(19) United States
(12) Patent Application Publication
(10) Pub. No.: US 2025/0181033 A1
(43) Pub. Date: Jun. 5, 2025

(54) MULTI-CELESTIAL OBJECT-RELATIVE CYCLIC TIMEKEEPING DEVICE AND METHOD

(71) Applicant: Episome Healthcare Investing and Consulting Services, Inc., Milton (CA)

(72) Inventor: Steven Moore, Milton (CA)

(73) Assignee: Episome Healthcare Investing and Consulting Services, Inc., Milton (CA)

(21) Appl. No.: 18/875,854

(22) PCT Filed: Jun. 19, 2023
(86) PCT No.: PCT/CA2023/050847

§ 371 Date: Dec. 17, 2024

Related U.S. Application Data
(60) Provisional application No. 63/353,228, filed on Jun. 17, 2022.
(60) Provisional application No. 63/414,030, filed on Oct. 7, 2022.

(51) Int. Cl. G04B 19/26

(52) U.S. Cl. CPC G04B 19/262

(57) ABSTRACT

Method and device for celestial timekeeping that synchronizes independent object-relative cyclic time and displays each unique temporal interval on a single user display system. Multi-celestial cyclic time is displayed based on a user's frame of reference by aligning with recurrent and unique cyclic start/stop signals and the local reference frame timekeeping system. For example, using the Coordinated Universal time (UTC) for a user on Earth to equate the duration of independent cyclic time of Lunar18, Mars24, and so on. The method uses dimensional analysis and equates a single cyclic, non-cyclic (zero-time; start/stop non-dimensional instant of a cycle), and linear continuous time [T] from an observer frame of reference for displaying one or more temporal cycles on the user's device. Each independent cycle is consistent with temporal counts of a whole cycle (equated to SI units) displayed as either a discrete geometric shape (spatiotemporal units) and/or algebraic numbers on the device.

### FIELD OF THE INVENTION

The invention relates to time-keeping devices and methods in general, with both a multi-celestial and lunation timekeeping device and method in particular.

### BACKGROUND OF THE INVENTION

There are timekeeping devices that display the International System of Units (SI) for solar and sidereal time related to Earth's standardized timekeeping system, described as the Universal Coordinated Time. These units include dihedral 24 symmetry for planetary rotation and are related to an Earth day cycle and can accommodate the various global time zones. However, timekeeping devices are currently not able to geometrically display and synchronize time intervals related to celestial motion for multiple celestial object spatial-temporal measures in a customizable user interface on a single device, linked to a single standardized time interval.

### SUMMARY OF THE INVENTION

There are no current timekeeping systems that are able to geometrically display orbital months (moon orbits) or years (planet orbits), while also presenting comparative orbital speeds of two planets (capable of being from any different star system) utilizing discrete geometric temporal vectors on a two-dimensional plane (circular or linear geometric models) that presents a known planet's orbit spatial and temporal measures as a canonical reference that can then calculate unknown orbital velocities and orbital distances.

There is currently no timekeeping system, or timescale, for the Moon that is independent of the Earth's solar rotation and time scale (Universal Coordinated Time). The European Space Agency estimates clocks on the Moon gain around 56 microseconds, or millionths of a second, per 24 hour period. An independent lunar timezone is challenged by being in a different observer frame of reference when modelled using Einstein's theory of relativity. A method and device that enables an independent moon time that can also synchronize with independent Earth daytime has yet to be proposed. Beyond independent timekeeping in lunar specific symmetry temporal hours, minutes, or seconds, an integrated calendar system that synchronizes Earth's axial rotation with a Moon timekeeping system has also yet to be proposed. There is also currently no method that can have two independent Earth and Lunar time systems, nor synchronize these independent time scales with a calendar system consistent to both celestial objects and frames of reference. A calendar system with shared months and years that includes both object-relative temporal cycles (Earth's rotation and lunation cycle). Beyond the missing method, no device exists for a user to select between either time scales for Earth or Moon based which observer frame of reference the user is on.

In a time-derivative model, each celestial object is in constant three-dimensional motion and individually affected by invariant forces and other factors that alter tangential velocities, orbital distance, and so on, each impacting entity specific time and space measures that rely upon time-derivatives. Also, by current time-derivative modelling systems (including timekeeping devices), celestial time intervals are not considered a fixed physical quality and thus not useful for a precise time interval. The International System for time presented a singular solution by developing a standardized unit of measure defined by a physically quantity, a finite number of cesium-133 (Cs-133) transitions. This standardized time is based on a mathematical time-derivative function. There is currently no device that is capable of selecting variable cyclic measurements and record deviations between predicted and observed differences for both space and time related to cyclic start-stop coordinates for objects.

A clockface is a standardize geometric model for a celestial cycle (Earth's rotation) with each count k (a count in this application is a specific interval of time for a defined orbit or rotation of a defined planet (celestial body) that can be converted to an SI unit second) representing both a distance required to make a full cycle on the clockface correspond with the defined interval of SI unit time. Based on a static geometric model (e.g., 12-hour clock), a circular geometric presentation of 12(60²) divisions; no other timekeeping device has expanded the application of using other celestial objects (objects defined as; stars, planets, or satellites) to construct and display class specific geometric models (classes defined as; orbit, rotation, axial precessions, and various cycles). No timekeeping device has been invented that can overlap display of multiple planetary 24-clocktimekeeping, orbital times, and calendars that can keep accurate (and comparative) time based on a standard SI units in a customizable display.

Orbital periods for celestial objects are managed using a conversion factor related to SI units of time and measured in Earth days (SI units). Current timekeeping devices and displays do not (1) temporally divide and subdivide orbit and rotation (discrete time variables) in a way that provides unique geometric temporal and spatial units for each entity that can be converted to SI units, (2) utilize universal orbital positions to unify modelled start (tₓ) and stop (tₓ+Δt) positions in space for any orbiting body that both sets a geometric modelled cycle and spatial distance that can present an object in showing individual spatio-temporal information into a single display to present individual celestial time the advances by SI units, (3) use geometric representation of an orbit that can be a canonical reference, also referred to as a discrete time variable, for distance and temporal intervals for comparing other orbits to learn their relative orbital distances, periods, and calculable orbital velocities, or (4) present scalable temporal orbital information for multi-celestial objects simultaneously on a device display (digital, holographic, or mechanical).

As space missions launch assets onto other celestial objects in the solar system, there is no single timekeeping device for a user to toggle to a selected celestial object and related time-zone related to these off-planet assets. Nor is there a device capable of tracking deviations from predicted time and space coordinates for cyclic orbital positions.

As explorers begin to travel and establish off-world bases of operations (on the Moon and Mars for example), or document other star systems and exoplanets, timekeeping devices will need the capability to display and toggle between a user position, destination, and Earth time. Such a device requires a user interface to select multiple time/calendar displays, and toggle between particular (1) star systems, (2) planets within a star system, (3) celestial object(s) like moons or satellites, and (4) manage particular time zone(s) for a selected planet(s). In short, any object-relative cycle can be utilized. Cycles are recurrent and use a defined start/stop position, the temporal interval may vary one cycle to the next.

Modern application of historical division and subdivision(s) counts of an Earth day (rotation) cycle use N=24(60²)=86 400 seconds. In this example, 1 k count equals one second per Earth day with additional precision measured by a multiplication of a base-10 decimal notation system. Using present inputs of time and a decimal based conversion system, rather than principles of unit fractions, creates imprecision as time approaches zero. Converting SI-units shown in decimal notation into unit fractions with expanding the denominator (N=24[60²]×10ⁿ), or for cyclic time, such as orbits and any particular calendar year (N=12[30ⁿ]), introduces a technology for timekeeping that enables precision for extremely short time increments without rounding that matches present inputs. The approach creates necessary technology to synchronize finite time and space measures from multiple celestial (or atomic) cycles for geometric comparisons, a technology applicable for the presented timekeeping device invention. In certain embodiments, another dimensional time base unit can be used in place of SI units.

Time on Mars (Mars24) has also been assigned using a similar solar reference and temporal unit counting system (as apposed to a sidereal rotation) but there is no dual Earth/Mars watch with customizable time zones for each planet on a single device. There is currently no time counting system unique to the Moon that can subdivide a Moon's lunation cycle as well as present decadals or years as well as divided and subdivided units of time, or present a multi-celestial timekeeping device.

Accordingly, the present disclosure in certain aspects relates to a method and a device for celestial timekeeping that synchronizes independent object-relative cyclic time and displays each unique temporal interval on a single user display system. Multi-celestial cyclic time is displayed based on a user's frame of reference by aligning with recurrent and unique cyclic start/stop signals and the local reference frame timekeeping system. For example, using the Coordinated Universal time (UTC) for a user on Earth to equate the duration of independent cyclic time of Lunar18 (discussed in the present disclosure), Mars24, and so on. A method according to certain aspects of the present disclosure uses dimensional analysis and equates a single cyclic, non-cyclic (zero-time; start/stop non-dimensional instant of a cycle), and linear continuous time [T] from an observer frame of reference for displaying one or more temporal cycles on the user's device. Each independent cycle is consistent with temporal counts of a whole cycle (equated to SI units) displayed as either a discrete geometric shape (e.g., circle) (spatiotemporal units) and/or algebraic numbers on the device, calculated or stored using the device CPU and/or memory. Each independent cyclic interval is reset at the beginning (start signal) of each unique cycle used in the display. Cycles can be unique object relative intervals (single cycle) but also frame intervals (more than one recurrent unique cycle) synchronized by pairing functions with more than one object-relative interval(s). Pairing functions synchronize cycles with shared celestial alignments that can reset and resynchronize a shared timekeeping system across multiple frames of reference. Methods according to aspects of the present disclosure can include multi-celestial cyclic and discrete count synchronizations between two or more frames of reference. For example, an exoplanet cyclic interval (orbit or rotation) synchronized to Earth's orbit or rotation, or a New Moon observed and synchronized using Earth's rotation and the Moon's lunation cycle.

The present disclosure in one aspect relates to a method of celestial timekeeping including A) selecting a first celestial object, B) selecting a second celestial object which undergoes a motion cycle where the motion cycle is defined relative to the first celestial object, C) selecting a reference to serve as both a start and a stop for the motion cycle, where the reference is defined by a relational event shared by the first and second celestial objects, D) providing a measured time interval between the start and the stop of the motion cycle for an iteration of the motion cycle, E) using the measured time interval as a predicted time interval between the start and the stop of the motion cycle for a subsequent iteration of the motion cycle, F) providing an elapsed time measured from the start of the subsequent iteration of the motion cycle, G) using the elapsed time to calculate a position of the second celestial object in the subsequent iteration of the motion cycle, H) outputting the position of the second celestial object to a user; and updating the position of the second celestial object by repeating steps F) to H).

The present disclosure in one aspect relates to a celestial timekeeping device including a display; a processor communicatively connected to the display; a memory communicatively connected to the processor; a communications interface communicatively connected to the processor; the processor configured to implement an instruction set comprising processor instructions comprising instructions for: A) receiving a user selection of a first celestial object; B) receiving a user selection of a second celestial object which undergoes a motion cycle where the motion cycle is defined relative to the first celestial object; C) receiving a user selection of a reference to serve as both a start and a stop for the motion cycle, where the reference is defined by a relational event shared by the first and second celestial objects; D) receiving, via a communications interface, a measured time interval between the start and the stop of the motion cycle for an iteration of the motion cycle; E) using the measured time interval as a predicted time interval between the start and the stop of the motion cycle for a subsequent iteration of the motion cycle; F) generating an elapsed time measured from the start of the subsequent iteration of the motion cycle; G) using the elapsed time to calculate a position of the second celestial object in the subsequent iteration of the motion cycle; H) plotting the position of the second celestial object to the display; and updating the position of the second celestial object by repeating instructions F) to H).

Accordingly, the present disclosure in one aspect relates to a customizable multi-celestial timekeeping device that uses entity specific units of present time and distance to provide a device with a customizable display capable of synchronizing and displaying multi-celestial cyclic time periods, including rotations, orbits, or cycles, as well as calendars for a user. SI units serve to synchronize and temporally advance a time-integral geometric celestial space-time models in counts of k within a current cycle. The timekeeping device can either be a mechanical, digital, or holographic. Digital devices can update entity specific spatiotemporal cycle information that can accommodate ongoing shifts, given the integral kinematic approach to present synchronized motion, accuracy will be decreased over time if future outputs are not accurately calculated, just as SI unit seconds are becoming less representative to Earth's rotation given the slowing tangential velocity of the planet.

The present aspect in one aspect relates to a methodology to collect data, and highlight inaccuracies, between future predictions of spatial and temporal coordinates for objects in a cyclic relationship and their actual observations. Spatial information includes noted distances in defined orbital positions (e.g., apogee, perigee, etc.). Temporal information includes the moment in continuous time the object occupies this spacial location with noted spatial distance to the orbital parent. This methodology creates datasets over time that can be used to test mathematical formulas and theories with a goal to increase accuracy in predictions of spatial and temporal coordinates of objects in cyclic relations, including external influences.

The present aspect in one aspect can extend beyond a device that captures celestial-based motion and can also be used to base time on any object-relative cycle, including photons, atomic and subatomic cycles, like an electron orbit period for an atom, rather than a planetary orbit period of a star. as given the mass properties of an electron is less affected by gravitational influence.

The present disclosure, in one aspect, utilizes the relational theory for space, time, and motion built upon from core concepts from Leibniz relationalism that is independent of the theory of relativity proposed by Einstein. The approach creates object-relative time but can also accommodate a user frame of reference with calendredic synchronizations between the two object-relative timekeeping systems using a shared temporal period frame of reference both independent frames of reference can be included in. A temporal period frame of reference is defined as being a cyclic temporal interval measurable by a standard unit of continuous time measure (e.g., SI unit seconds) defined by measurable signal inputs and outputs, or start stop signals for a cycle. The invention integrates the signal system to assign discrete time modeling with uniform natural number temporal units for each cycle and object-relative period of time. Lunar time counts align with division and subdivisional scales of Mesoamerican timekeeping systems, modified from existing published intepretations the unite were used as a vague solar year based on Gregorian timekeeping comparisons from literature. Periods of time can be either a sample (temporal interval between two astronomical signals) or frame (more than one recurrent sample) periods. Relational astronomical signalling and defined cyclic start/stop utilize an object-relative relational timekeeping method for creating independent object-relative timekeeping and multi-object cycles that can be synchronized for calendar systems and devices for a particular user's frame of reference (celestial body).

The present disclosure, in one aspect, relates to a multi-celestial timekeeping device including entity specific integral space and time geometric models build upon a zero-time system, a uniformly subdivided region (Δtₓ), or period that can be either a temporal sample period (Tₛ) or temporal frame with more than one recurrent sample periods (T_{f}), creating uniform and discrete k counts between two points in space and time (tₓ and [tₓ+Δtₓ]) defined as the non-zero region of discrete time, with time added to the system by synchronizing timing of integral kinematic motion using conversion factors related to standardized time-derivatives (a second SI unit for example); and a customizable digital display for a user to select various properties for the celestial bodies and related temporal intervals of interest; and a fixed mechanical display for particular celestial bodies using related timekeeping temporal counts and spatiotemporal models; class specific units counts for orbits, rotations, and cycles and when presenting multiple celestial objects, a canonical reference of a single cycle sets the reference duration of the selected multi-celestial objects in the timekeeping display.

The present disclosure, in another aspect, relates to Lunation time counts for Earth's Moon to be used in a celestial timekeeping device including a single lunation cycle divided into temporal counts of 18 uinals (where a urinal is a Maya month) with 20 kins (a kin being a day) each uinal, and in a further aspect, relates to presenting ancient timekeeping measures in a device that allows for geometric presentations of celestial information for comparisons and presentation.

The present disclosure, in another aspect, relates to a timekeeping device with a customizable user interface capable of presenting accurate geometric modelled time that simultaneously integrates multiple celestial temporal intervals. A user can select celestial object(s), time zones, and orbital times for the display. This object requires various attributes and mathematical processes, including but not limited to (1) building integral space-time geometric models of discrete temporal positions, (2) class specific cycle divisional count system that is combined with mathematical application of mixed unit fraction characteristics and ordered temporal units, (3) a defined class specific canonical (set reference) position (space) and time (tₓ) (with interval Δtₓ) for comparative display of intervals (e.g., orbit to orbit), (4) a spatial scaling system to conserve relative orbital distances to a parent body while conserving temporal relationships, (5) a start/stop cyclic reference in space to define a temporal interval (Δtₓ; discrete time variable), including rotation (parent star or distance fixed star), orbit (start/stop, apses), or cycle (calendric references)), as well as (6) a standardized unit for time that includes a time-derivative for the device that synchronizes and moves geometric components, using geometric motion, of the timekeeping device.

A model according to an aspect of the present disclosure defines model two-dimensional planes using defined 1 D line segments that are object specific spatial geometric measures that are uniformly scaled to fit within the device display (any size). To set the points for each unique 1 D line, celestial motion is frozen in a defined moment of zero-time (Δtₓ interval of discrete time). This defined 1D line is referred to a fundamental element (spatial). The 1D line (fundamental element) for an orbit is calculated from the stop time point in space (an indivisible time unit (tₓ+Δtₓ), connecting the geometric center of the orbiting object and parent that is uniformly scaled for display in the device, in cases informing the scaled geometric temporal display in the device construct (e.g., line segment size, circle (radius), or polygon [radius]). Multi-celestial orbital displays maintain the same uniform scaling of the input (Δt) into k counts, with different seconds/k count to conserve relative proportions of displayed orbits, creating equivalence relations. The time interval (a present input of Δtₓ) is defined for each object or orbit through the same start/stop position that also defined the fundamental element (taken at the cycle stop point in time and space [tₓ+Δtₓ]) for a particular display. Start/stop positions are set at points along a rotation or orbital path that is consistent for all objects (e.g., apoapsis for orbital time and/or observer reference of a star for object rotational time [fixed or orbital parent]) for a particular device display. Accuracy in the measure is as accurate as current measuring capabilities, for example Earth's orbital time defined by an orbit cycle from aphelion (start point) on Jul. 4, 2022 (07:11 Greenwich Mean Time [GMT]), following aphelion stop position on Jul. 6, 2023 (20:07 GMT), accuracy can extend to seconds and further when possible. Updated spatial distances are an output based on (tₓ₊₁) device display. Whereas exoplanet orbital time would be less accurate due to current limits in available information.

In a device according to an aspect of the present disclosure, display accuracy is related to differences between observations and calculated predictions for future cycle stop positions in time and space (tₓ+Δtₓ) with actual observational inputs for the start of the next cycle (tₓ₊₁). Calculations for the object-relative position in time and space (related to the fundamental element) are calculated from (tₓ; start) to project future position in time and space coordinates at (tₓ+Δtₓ; stop). Present inputs, represented in uniform scaled k counts, predicts a future cycle stop point in time and space. If differences between predictions and observed spatiotemporal coordinates are accurate, coordinates perfectly align with next cycle, where (tₓ+Δtₓ)=tₓ₊₁ Any differences between predicted future coordinates [tₓ+Δtₓ] and observed tₓ₊₁ are related to limitations in mathematical calculations of future events in time and space, captured by a CPU and stored in memory. To adjust devices for these differences, inputs to a CPU are possible (see FIG. 7) which can also provide inputs to CPU 2 that controls the device display. Without a feature to align differences between calculated and actual will accumulate to a point the device's usefulness will become limited.

The present disclosure, in one aspect, relates to using a zero-time space-time geometric modeling with motion captured using integral kinematics used to create a timekeeping device that can include a customizable user interface that present and synchronize unique multi-celestial timekeeping systems. Motion is captured in the devices using entity specific temporal vector elements with entity specific length and time properties related to the calculated spatial and temporal input (Δtₓ), but the comparative celestial represents (e.g., orbit to orbit or rotation to rotation) share the total count (N) and unit divisions. These units are place on the display as ordered counts (k) of a whole, k/N where when k=N the cycle is complete and one cycle mathematically presented as a mixed unit fraction,

$$1 \frac{0}{N} .$$

The timing of the placement for each k count in the device is determined by converting the temporal properties into a standardized time-derivative unit of measure (e.g., second SI unit).

Geometric calendars are constructed using step up mixed fractions where the whole number of a mixed fraction becomes the numerator of the next step in time cycle. For example, 12/12 months, or

$$\frac{12 months}{12 months} = 1 year \frac{0}{12 months}$$

and can also grow into decades (10 years), or

$$\frac{10 years}{10 years} = 1 decade \frac{0}{10 years} ,$$

and so on.

The present disclosure, in another aspect, relates to a time interval for the Moon's lunation cycle necessary for a Moon specific timekeeping device. The Moon is a satellite orbiting Earth and thus the cyclic orbital time is defined using a start/stop privilege point in space, a New Moon (setting one lunation cycle). A New Moon is defined by the position of the Moon taken between Earth and the Sun at the moment when the Moon's center of mass lies directly on, above, or below, a line segment modelled by two points marked by the geometric center (centroid) for both the Earth and Sun. The division and subdivision of time for one cycle (lunation) is based on 18 divisions (termed uinals), each with 20 subdivisions (termed kin), similar to setting a division of Earth's 24 hours each with 60 subdivisions (minutes) in a rotation rather than orbit.

In the present disclosure, multi-celestial objects in a display can include a planet with orbiting satellites and moons, to planets orbiting a parental star, as well as stars orbiting a galaxy's center. In another aspect, it relates to a user interface wherein the user can transition a display that can include select star systems (with selectable planets in that star system), select planets from differing star systems. But also include features like selecting a planet to display selection of orbiting satellites for that selected planet. Information is displayed on a two-dimensional (2D) plane (a watch face for example) as stacked 2D planes centred on an object specific parent object with a shared zero-dimensional point (geometric centre). If a 3D display is used, the zero-dimensional point can be used to create relative tilts of individual orbital planes as compared to an invariable plane (applications include holographic imaging systems).

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagram of depictions of celestial orbits according to aspects of the present disclosure;

FIG. 2 is a diagram of graphical displays according to aspects of the present disclosure;

FIG. 3 is a diagram of graphical displays according to aspects of the present disclosure;

FIG. 4 is a diagram of geometric relationships between a celestial object and its satellite;

FIG. 5 is a diagram of graphical displays according to aspects of the present disclosure;

FIG. 6 is a schematic representation of sequential object-related cycles;

FIG. 7 is a schematic of a devices according to aspects of the present disclosure;

FIG. 8 is a schematic of a devices according to aspects of the present disclosure;

FIG. 9 is a schematic of a device according to an aspect of the present disclosure; and

FIG. 10 is a schematic diagram of different models of astronomical motion for Earth and the Moon.

### DETAILED DESCRIPTION

Throughout this specification the word “comprise”, or variations such as “comprises” or “comprising”, will be understood to imply the inclusion of a stated element, positive integer or step, or count, or group of elements, integers or steps, but not the exclusion of any other element, integer or step, or group of elements, integers or steps.

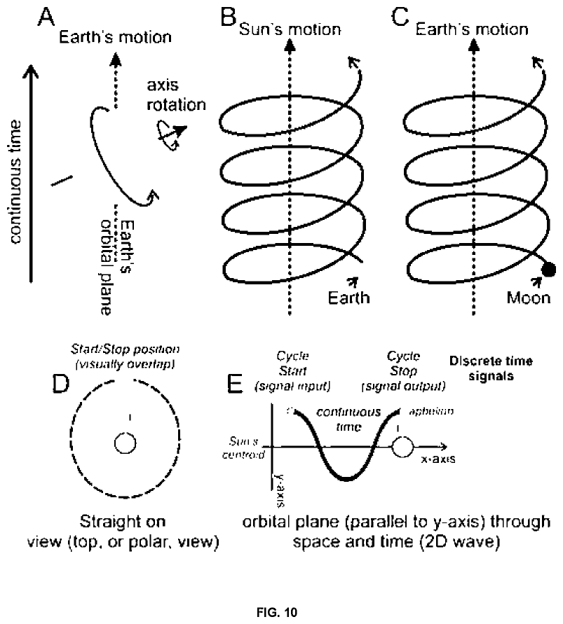

Unification of continuous and discrete time in this article begins by using three common astronomical cycles in ancient timekeeping: Earth's axial rotation (day with a solar reference) (FIG. 10A), Earth's orbit around the Sun (orbit with one of many fixed cyclic defined points) (FIG. 10B), and the Moon's orbit around Earth (with fixed cyclic defined point; New Moon) (FIG. 10C). To appreciate cyclic unique temporal intervals, let us consider that a familiar approach to model astronomical cycles. Kepler's first law describes an orbit as being elliptical (FIG. 10D), however this is only a partial picture, a flattened model that gives an approximation of a so-called elliptical orbit. However, it is not a precise elliptical shape given the dynamical nature of an orbit. Planets, well as light (22), move through space with both spin and orbital angular momentum and they do not reoccupy the same position. One aphelion position is not the same in 3D Cartesian space as the next time the planet occupies the next defined aphelion position. To simplify the introduction, a three-dimensional (3D) orbit can be modeled using a two-dimensional (2D) wave model, depending upon the selected signal input(s). A single spatial position (e.g., aphelion) can define an orbital start/stop point for a sample interval of time, unique to each cycle.

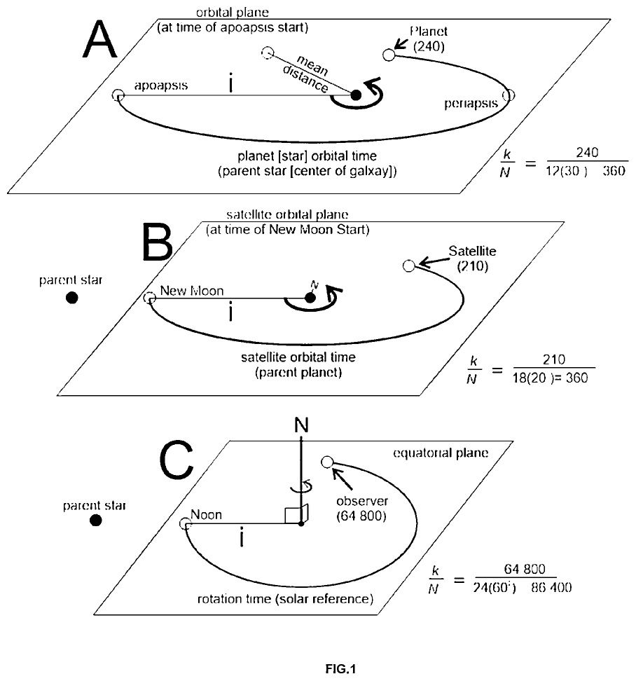

Signal input points can be selected from universally-defined orbital positions (e.g., apsides), ancient timekeeping systems (New Moon), or even neolithic site celestial alignment markers (like sunrises on summer solstices). The start/stop (signal) points are based on definitions universally present in each cycle. For the Moon, a universal position in space and time is a signal used in ancient timekeeping, a New Moon, or the point where the Moon is in line between the planet and the Sun (FIG. 1B). Axial rotation cycles can have either a sidereal (distant fixed star) or solar rotation (FIG. 1C). Both rotations can be divided into 86 400 equal counts of a whole rotation (e.g., 86 400/86 400=1). For perspective, a solar reference is used for a measure of time and a sidereal rotation does not include the additional distance traveled to compensate for the curved orbital path around a star, so time measured for a rotation for Earth relative to a fixed star is less—86 400 uniform geometric divisions of a sidereal rotation of Earth occurs in approximately 86 164 seconds.

FIG. 1 is a methodology to define (1) two-dimensional plane for a device display, (2) spatial distances (fundamental element being the object-relative stop position in space which is a distance taken measure taken during the calculated Δtₓ) used for uniform scaling needed to create the equivalence relations in the device display, (3) single rotational and revolution cycle(s), and (4) designation of cycle start/stop positions. Three shown options for a universal start/start cyclic point that is universal to all orbits, apoapsis, periapsis, and mean orbital distance (open circles). For displaying multi-celestial orbital displays, the same start/stop point (apoapsis shown) in each respective orbit is used for clarity. Fundamental elements (i) in (FIGS. 1A, 1B and 1C) are defined by the calculated stop position fundamental element position in space and time for a object-relative cycle. An ideal start/stop reference for a satellite (moon) time interval would be when there is an alignment of a “New Moon” with the satellite's apoapsis position. The example utilizes a universal system of N=12(30″), where n=1 and N=360, shown to capture the temporal interval with position of object (planet) shown in

$$\frac{k}{N} = \frac{240}{360} .$$

FIG. 1B is a two-dimensional display model created by a 1D line connecting the center of the satellite and the orbiting parent (not a star, presented on a different plane). Interval (i) in FIG. 1B defined by same options as described in FIG. 1A (apoapsis, periapsis, or mean orbital distance) but the temporal start position is independently defined by New Moon position (satellite directly in line with the parent body and the start the parent body orbits (star shown). Temporal units shown in example use a distinct N=18[(20)ⁿ] where n=1 and N=360, satellite position shown in

$$\frac{k}{N} = \frac{210}{360} .$$

FIG. 1C is a two-dimensional display model representing a object rotation temporal interval using a solar reference as start. 1D line (i) in FIG. 1C for uniform scaling, and setting the 2D plane, is the equatorial plane shown. Distinct temporal units shown as N=24(60²)=86 400, with observer on object surface position shown at

$$\frac{k}{N} = \frac{64 \; 800}{86 \; 400} .$$

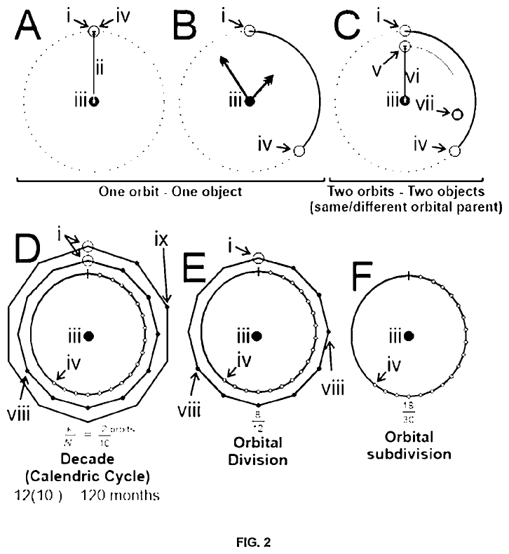

FIG. 2. shows a circular model on a two-dimensional plane, start/stop position (open circles), and scaled fundamental elements (object-relative distance relevant to orbital position at the measured Δtₓ₊₁) as defined in FIG. 1, which can, in one embodiment, be displayed on a user interface such as a smart watch or smart phone screen. Position of the object marker informed by unique k displacement distances calculated for each object, advancing as calculated by seconds SI unit. A single and dual orbital time (FIG. 2A, 2B, 2C) and multi-year calendar displayed (FIG. 2D, 2E, 2F). One circular orbit cycle is created with the radius of the circle or 360-gon using a uniform scale of the fundamental element (ii) defined start/stop orbital position (i) (e.g., periapsis) of object (iv) compared to the parent object (iii). Temporal movement of object iv shown at start/stop position with k=0 (FIG. 2A) and in k>0 (FIGS. 2A and 2B). FIG. 2B shows how clock hands for a selected planet or object rotation rate can be displayed using standard N=12(60²) methodology but moving at a time that is unique for the selected object (as shown in FIG. 1C). FIG. 2C adds object (vii) temporal and the temporal start/stop position in the display (v) (same orbit defined point for an orbiting object [e.g. periapsis] as shown also by (i) and as (v) with the object specific fundamental element uniformly scaled using the same formula for (ii) so the 1D measure (radius) between the start/stop and object's parent object point (iii) is proportional to (ii). Note: selected planet in the display from the same solar system use the same star, however it is possible to present time and relative orbital distance for two planets from more than one star system using the same methodology on a single display and each star overlapping with the zero-dimensional centre in example shown. Shown is a different method, object A calendar using N=12(30)=360 unit counts per orbit (FIG. 2D to 2E). FIG. 2F presents orbital subdivisions (n=30) of time for a single planet, or defined cycle (if using the divisional count as a universal system), here shown using a 30-gon with each node showing a marker at the relevant time of the object's orbit of parent (iii) with position in time indicated in most recent marker (iv). FIG. 2F uses orbital time divisions (n=12) as a second geometric shape (12-gons shown) with each node a marker to indicate the related time in the orbit relative to the division count (viii). One completion of the cycle represents one orbital year. Start/start position in orbit presented (i) of parent object (iii). FIG. 2D, shown with orbital division and subdivision, shown with two orbits completed of the ten solar orbit cycle (decade) as referenced by the indicated start/stop position (i).

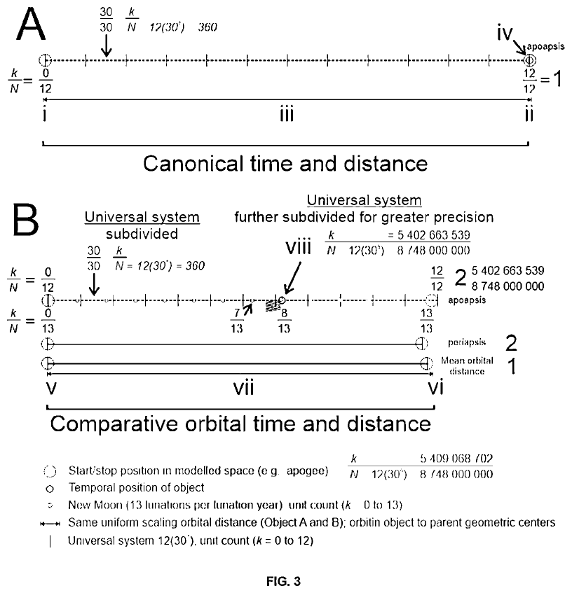

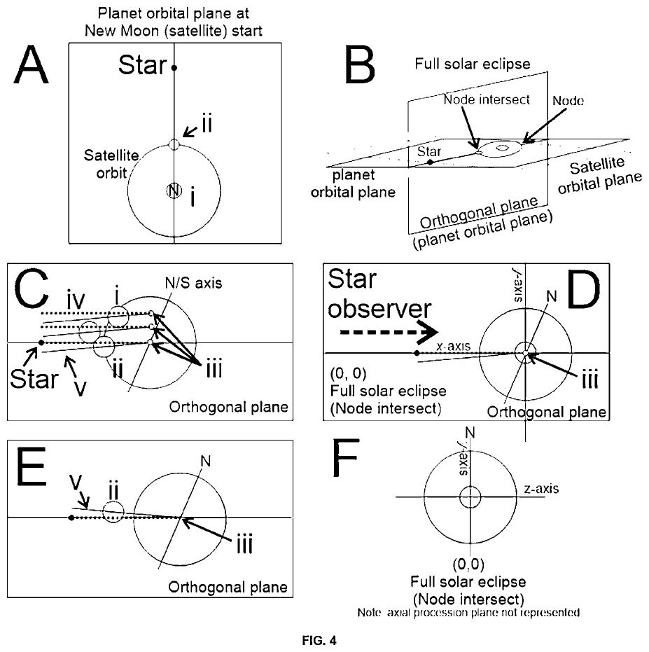

FIG. 3 shows how one object's orbital geometric representation for accurate distance and time that act as canonical (or reference) for a current geometric model display for both orbital velocity and orbital distance for another orbiting object can be represented, and can be displayed, on for example, a user interface such as a smart watch or smart phone screen. Example shown presents Earth and Moon as timekeeping references for planet object (unknown) in FIG. 3A using 13-lunation year calendar (synchronized to a point in 2/3 Earth's orbits) and Earth's orbit as a canonical reference (FIG. 3B). Objects do not need to be in the same star system and if one object's orbital distance and velocity is known, the other object's corresponding measures can be calculated, e.g., FIG. 3. presents with an orbital period that is equal to 2 5402663539/8748000000 Earth orbits from apoapsis position (e.g., Feb. 14, 2023, after Jul. 4, 2022, apoapsis). This calculation creates the input for Δtₓ used to predict future (tₓ+Δtₓ) spatial (distance from centroid for Earth to centroid for the Sun; fundamental element used for scaling) as well as temporal coordinates (seconds from tₓ to this prediction for tₓ₊₁). FIG. 3A presents object A's orbital information (with start/stop marker) as a one-dimensional line segment using two markers (i and ii) that are spaced apart using a uniformly scaled fundamental element that is the identical uniform scale as Earth's orbital distances shown in FIG. 3B (see FIG. 1 to present fundamental elements). FIG. 3A point (i) represents both a parent orbital body marker as zero-D (point on a 2D plane display) as well as a double meaning stop position (spacial coordinate) for both the orbital time (1D (iii) equally divided into N=12(30¹) and orbital distance that is uniformly scaled. Point (ii) represents both the temporal stop position in the orbit cycle (Δtₓ) and is spaced from (i) using the scaled fundamental element related to the object's orbital distance measured from the calculated cycle stop distance (see FIG. 1A for optional start/stop positions). The distance (iii) shown as being divided and subdivided into the universal temporal system N=12(30¹) to create noted divisions to resent one orbital cycle time and distance for object A. FIG. 3B presents the orbital information for object B (Earth), requiring the same fundamental element scale as iii in FIG. 3A, however, multiple line segments are shown, example shown is a parallel configuration, where each line complete line represents one orbital period. As object B orbits closer to the parent, using the same scale (proportional) as FIG. 3 Aiii, the line segment between v and vi is shorter. A partial orbital period is captured by a point on the 1D line (vii) that creates an origin point for a geometric construct of Earth/Moon lunation model (see FIG. 4) synchronizes 8/13 lunation counts with Earth's orbital position. The model can incorporate terminal positions for the Earth/Moon 13 lunation count based on absement modelling of motion using dimensional length and time that can incorporate a third cycle to the calendar, the number of Earth rotations in either a common year (384-days) or leap year (385-days) with a common year slightly shorter in total distance (not shown) yet still aligned with 13/13 lunation counts, with the 385-day position (shown) with minor differences is total physical scaled distances relative to scaled orbital fundamental element captured using physical geometric error bars (open circle representing 12/12 (orbital time period) and 13/13 (lunation count) in a 385-day leap year presentation. The methodology enables the position of the 8/13 lunation cycle, presented (using the centered geometric model from FIG. 3) in placement of dimensional time and length position in a 385-day leap year calendar. Eight parallel orbital planes of the Moon, centered on a Earth/Moon geometric modelled lunation cycle construct presents geometric redundancy for the position and count of the Moon's lunation cycle 8 (see FIG. 4C for more details). As v in FIG. 3B represents the start position, the distance from v to centroidal point of construct of object B (viii in FIG. 3Bi) creates a temporal position of the object which can be represented using precision by decreasing the unit size N=12(30⁶) as shown. The partial orbital period still requires the stop position marker (vi) to present this is a orbital representation at 12/12 with appropriate scaled spacing of the fundamental element. If the orbital distance and speed is known for either object A or B, the other object's information can be calculated.

FIG. 4 shows a geometric relationship between an object i (e.g. Earth) and its satellite ii (e.g. the Moon) as the satellite passes between the orbital parent and the star of the star system (see FIG. 1B), and can be displayed, on for example, a user interface such as a smart watch or smart phone screen. Both circles are constructed using scaled semi-minor axes (fundamental elements) as radii for the planet (Earth (i) used) and the satellite (Moon (ii) used). Two orthogonal planes presented include one defined by the 1D line connecting the centroid of the planet with the centroid of the parent star (FIG. 4A) and the second perpendicular to that plane (FIG. 4B). FIG. 4C shows multiple Moon and Moon/Earth model central convergent points for orbital planes centered on Earth's geometric center (iii) that can represent each lunation position in a given lunation for a lunation year of 13 Moon orbits of Earth (shown are 3 as examples). The planet orbital plane (iv) relative to the star and planetary centroid (iii), and the Moon's displayed orbital plane (v) with a position of the Moon along the orbital plane to indicate the distance (y-axis) from the planetary orbital plane, either above (FIG. 4E) or below (FIG. 4C), at time of the New Moon position. Methodology to present multiple FIG. 4D demonstrates geometric relationship that presents a full solar eclipse, a time when the Moon's orbit intersects with the Earth's orbital plane in a New Moon position. FIG. 4F presents the y- and z-axis for a full solar eclipse, a display that creates the same display on all three axes (x-, y-, and z).

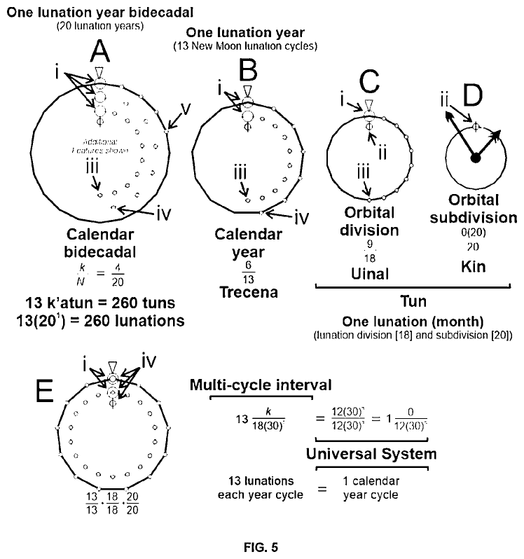

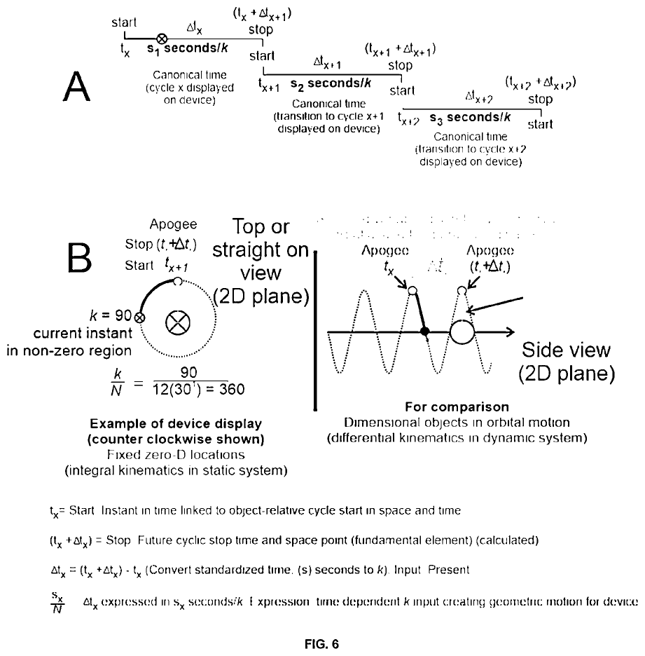

FIG. 5 shows a multi-layered lunation timekeeping representation with concentric geometric polygons to capture a bidecadals, years, divisions, and subdivisions (FIG. 5A-D), each year, lunation, or lunation division and subdivision as a point on the corresponding polygon for that unit count, which can be displayed, on a display, for example, a user interface such as a smart watch or smart phone screen. Additional wheels using n=20 counts would increase the cycle count by an exponent of 20, for example another wheel of 20 (not shown) would present 5200 lunation cycles, or 400 lunation years (13-lunations each year), in one full completion of a cycle. Shown is a 13 synodic month (New Moon start/stops) lunation year using 20-year cycle(s) that enable harmonization of Earth's rotation as a secondary cycle to the primary lunation cycle, referred to as luniterranean-13(20¹) with N=18(20) lunation cycle units. The full year (13 lunation cycles) can also be presented on a device display as a single rotation (or rotating marker rather then ticks shown at each polygon node by small circles as shown) by converting a calendar year time interval into the universal system of N=12(30″) FIG. 5E. The universal system enables options for cyclical or linear calendric models and canonical referencing (see FIG. 3 and FIG. 6). Example device display shows a primary lunation cycle with unit time division (n=18) and subdivisions (n=20) of (FIG. 5C-D). Common Maya calendar terms are shown as the unit counts align to an accurate luniterranean-13 calendar with necessary Earth intercalations (not shown) but can be presented in the display, as indicated in FIG. 5A. One lunation, or synodic month (New Moon start and stop), termed a Tun, equals in count to the division and subdivisions of (FIG. 5C) 18/18 Uinal=(FIG. 5D) 360 0/20 Kin). A calendar year is termed Trecena (group of 13 lunations) with a bidecadal presented as Trecena X 20¹. Triangle shown in grey presents the relative position of the star and the center of the concentric circle is centered on the planet that the satellite orbits, thus geometrically representing a New Moon at the position between the planet and the star. Month names and geometric configurations for any lunation-based calendars can be displayed using associated geometric configurations, e.g., luniterranean-12[30¹] or −12[19¹] respectively. (FIG. 5A-D, i) The start/stop position in time (e.g., New Moon) used to define the relevant cycle. (FIG. 5C-Dii) Time advances along each division (18) or recurring cycle, corresponding to relevant concentric cycle geometric shape (shown here as polygons with one node per count) by progressing counts (shown here as dots rather than a spinning wheel fixed to a point changing time display). One full turn, or presented markers along nodes (as shown), of the Calendar bidecadal geometry equals 260 lunations based on New Moon transition. Intercalary events (like a leap year, leap month, skipped hours, and so on) and related calendrically aligned day counts can be configured to either display (or not display) on the device with aligned with appropriate calendars and their names, symbols, numbers, and so on. Display can also integrate hour, minute, and second hands for any selected object rotation time, either the orbiting planet or another unaffiliated planet is possible as the object rotation and satellite orbital cycles are independent (FIG. 5D). FIG. 5E presents a 13-lunation year, shown here within the wheel model when all wheel markers present at a New Moon position. One 13-lunation calendar year can be is converted into a universal timekeeping system of 12 divisions and 30 subdivisions as a harmonization into an equitable counts, a system also used in the adapted Julian/Gregorian dual calendar (primary cycle is Earth's orbit, and secondary cycle of Earth's rotation with adapted intercalary events), but also referenced in various ancient texts. This conversion into an equitable universal system presents technology that enables canonical geometric measures of time to be constructed to compare orbital cycles of planets (even exoplanets from interstellar systems), see FIG. 3. Spatial distances utilize a separate uniform scaling system to time that is instead applied to the fundamental element (see FIG. 1), one example used from ancient texts can include N=360(60²)=1 296 000 (Dih₃₆₀), which enables technology for multi-layering for geometric datasets of time and distance.

FIG. 6A is a schematic representation of three sequential object-relative cycles, one cycle (the present cycle) used as a display for a device. Each subsequent cycle would update the device display relative to the canonical reference. Any object relative cycle can be used and compared to other like cycles (e.g., orbit vs. orbit) using the canonical time reference. Other like cycles have their own independent seconds/k count captured in the device (see FIG. 6A, object B-relative cycle). The cycle's invariable discrete time defined by an object-relative cycle's region between two time points, tₓ and tₓ₊₁. FIG. 6B Passage of time in the device is counted using discrete geometric motion within each display using the uniform counts of k that are equated to SI units (universal standardized time), so when k=N the respective object-relative cycle is complete. Complex motion of cycles can integrate greater complexity to align with dynamic motion and visually presented using wavelike (2D, shown, or 3D helical orbits not shown) displays as well. Each cycle is an input (Δtₓ) for a single display for a device, at each new cycle start point (tₓ₊₁) the display refreshes based on next “present” cycle calculated inputs. The refresh includes new information (spatial distances and seconds/k count) for the next object-relative discrete time interval for both space (scaled fundamental element), cycle start point in time (tₓ₊₁), and calculated input (Δtₓ₊₁). This aligned with a start for the next cycle (either using calculated (tₓ+Δtₓ), or a manual override on the device for entering a real-time observational input starting the next cycle start point (tₓ₊₁) with existing second/k count calculations (see [18]).

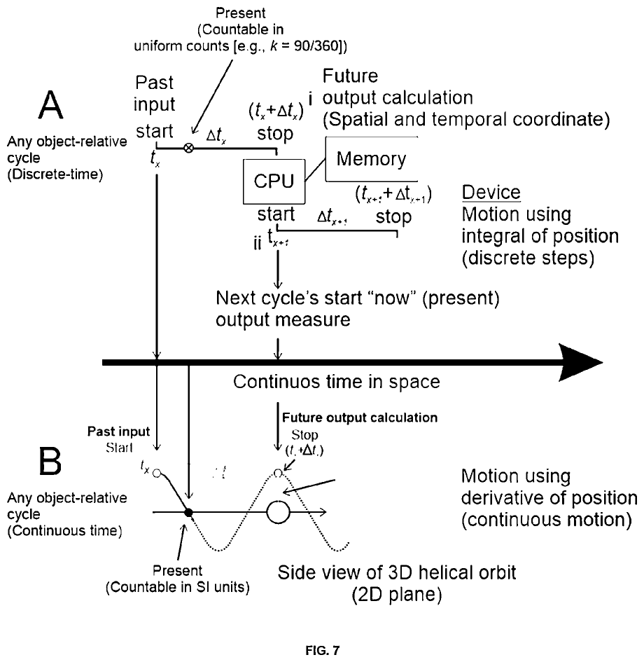

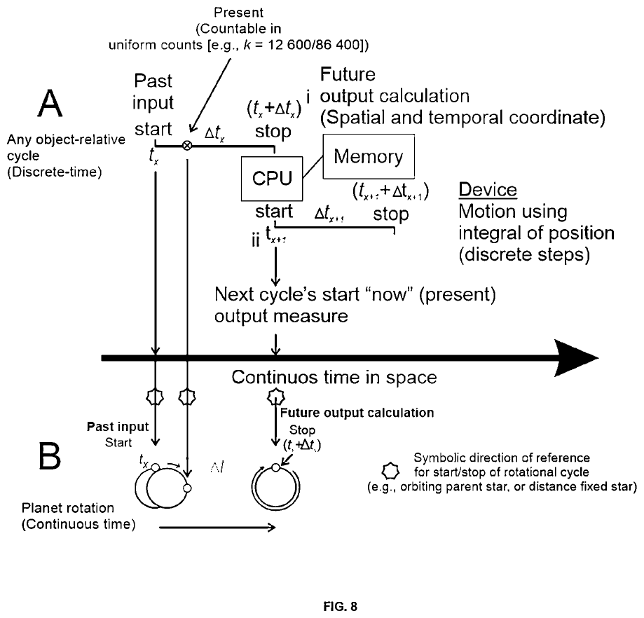

FIG. 7 is a schematic of devices and methods according to embodiments of the present invention that can be implemented in devices where the CPU and memory are programmed with instructions according to the embodiments of the present invention that includes the collection of data related to differences between the calculated spatial and temporal coordinates for each specified cycle completion (i in FIG. 7A) (at time of tₓ+Δtₓ) and the actual present spatial and temporal measures (FIG. 7Aii) taken at that instant (tₓ₊₁) (an input in the present). The CPU provides any new information to CPU 2 that implements any upcoming invariant discrete-time cyclic intervals (Δₜ₊₁) for the next cycle in the device display operations (see FIG. 8). CPU can update CPU 2 at regular intervals to increase accuracy for timing the device display. Inputs for the CPU spatial and temporal cyclic information can be either programmed for all future cyclic start/stop positions, use an interface to enable receiving recurrent external input from an external device, or manually input. The CPU manages information related to comparative cycles used in the device. FIG. 7B is a schematic representation of an equivalent orbital cycle using continuous time, derivatives of displacement, and a 2D side view display of a 3D helical orbit path. Top of the waves indicate a selected orbital reference point (e.g., apiside).

FIG. 8 is a schematic of devices and methods according to embodiments of the present invention that can be implemented in devices where the celestial frame of reference CPU and memory are programmed with instructions similar to FIG. 7. CPUs from independent celestial frames of reference can be linked to a shared temporal period frame of reference that aligns a shared frame period of two independent frame periods (calendar system) through pairing or other functions. Shown here using a relational object (planet) axial rotational cycle for a discrete object relative and cycle dependent temporal interval, measurable by SI units, using a defined reference (Sun, but distant fixed star is also possible) to define a temporal interval input (Δtₓ).

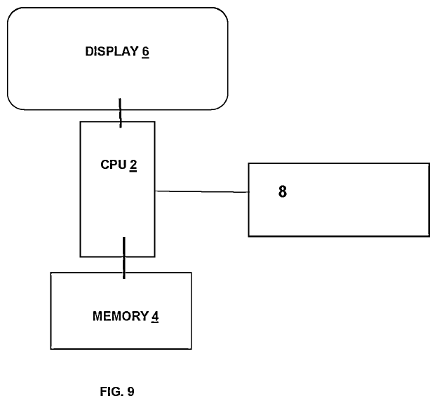

FIG. 9 is a schematic representation of a device on which the present invention may be implemented, wherein the device includes a CPU 2 operably connected to a memory 4, a display 6 and a communications interface and link 8. The memory 4 contains computer instructions for carrying out methods according to embodiments of the present invention and displaying timekeeping representations according to embodiments of the present invention on display 6. For example, the example any of the individual representations (identified by sub-figure references “A”, “B” etc.) in FIGS. 2-5 could be displayed on display 6. Each frame of reference can utilize a celestial specific independent CPU and memory system to calculate predicted distant object temporal period relative to the user frame of reference. communications interface link 8 can be used to receive a measured time interval between the start and the stop of the motion cycle for an iteration of the motion cycle from an external measurement or data source. For example, the received measured time can be obtained by linking, wirelessly or through a wired network, using conventional communications technology, either directly or via the internet or the Cloud, to a database of astronomical and celestial data such as those maintained by the International Celestial Reference System (ICRS) or NASA.

The present invention, in one embodiment, utilizes mixed unit fractions

$$( \# \frac{k}{N} )$$

where the denominator (N) represents the number of divisions of a cycle input (Δt), the numerator (k) represents an ordered count of incremental units, and the whole number is the count of completed cycles. N represents a uniformily divided Δtₓ input for distance and time calculated to represent coordinates in space and time for (tₓ+Δtₓ). Using natural numbers, without zero or decimals, one cycle would be defined as a sum of temporal elements across a split numerator

$$( \frac{N}{N} = \frac{1}{N} + \frac{1}{N} + … ) ,$$

where N is defined according to the cycle's total divisional unit counts. The unit fraction utilizes set theoretical principles and does not include zero, or an empty set (since no geometric element can be empty). Thus, the inclusion of an empty element can be shown in counts as

$$( \frac{k}{N} = \frac{0}{N} + \frac{1}{N} + \frac{1}{N} … )$$

where k can equal 0 (or an empty element) and k=1 representing the first ordered element of a cycle. When k=N, the cycle count is complete. In modeling, zero becomes a non-divisible point, a start and stop position for a cyclic construct of time, for example,

$$\# \frac{k}{N} ;$$

$$where$$

$$\frac{13}{13} = 1 \frac{0}{13} .$$

The present invention, in one embodiment, relates to a geometric definition for each selected temporal interval (rotation, orbit, or cycle involving things like axial procession or greater than one orbit) and aligned using class specific sequence of operations requiring setting a class (Dₙ) specific divisor to define geometric temporal elements. In this invention, units are selected from historical contexts. A divisor (where N=divisor[(subdivisor)^{y}]) is associated with dihedral group symmetry (Dihₙ) will enable downstream multi-dimensional geometric modeling functions. The temporal interval, or complete cycle, can also be defined by 1 temporal element (linear or circular) set by a modelled reference position in space (see FIG. 1) that marks the start (tₓ) and calculated stop (Δtₓ) position in space and time. The temporal element is divided and subdivided into smaller geometric elements to create the desired element length (using a scaled model in zero-time) and multiplicity (N) required for the model, these divisions/subdivisions can be used to present equal number nodes on polygon geometric constructs for example. An example would be a universal system with 12 divisions, each subdivided into 30 smaller geometric elements, N=12(30)=360 that can include a single cycle or a cycle of multiple cycles, like orbital months in a lunation year. The ordered sum of the smaller geometric elements equals the full cycle temporal interval using unit fraction principles.

To calculate the multiplicity of the multiset (N), and the unit fraction denominator, the temporal element is sequentially divided (n) and then subdivided (f[b]) with uniform scaling. Temporal counts are divided, subdivided, and scaled in the following convention:

N=n[f(b)], also shown as N=n[f(b)]
N=total count
n=divisor (dihedral symmetry)
b=sub divisor (base system, typically a radix number)

An example formula (e.g., N=n f (b)) will allow for greater precision of temporal measures.

N[(f(Nsf))]=N^{↑}
where Nsf is the “N scale factor” used to present scale of a defined unit of measure

e.g., f(Nsf)=10²

### Examples Include:

### Orbital Cycle of an Object.

N=12(30¹)=360, which can also be further subdivided where N=12(30)²=10 800

### Rotation Cycle of an Object (e.g., Symmetry for Planet Axial Rotation: Earth).

N=24(60²)=86 400, which can also be scaled where N=24(60²)×101=864 000.

### Lunation Cycle (Synodic Month)

### Independent Symmetry for Lunar Time

One lunation cycle (New Moon to New Moon relative position between Earth and the Sun) is not a rotating planet so it would require unique symmetry, divided and subdivided into units of lunar time. N=18(20¹)=360, or 18 lunar hours, each with 20 lunar minutes, and expandable to 20 lunar seconds. This can be a time scale for a user on the Moon (Moon frame of reference) set by a local coordinate time system that can also be synchronized to the relational planet's cyclic rotational time (24 hr, 60 min, 60 sec) using this invention's methodology. And vise versa, a user can be on Earth using a device set to the Universal Coordinate Time (UTC) and synchronize to the Moon's cyclic lunation time scale.

### Earth/Lunar Calendar System (Luniterrerean)—Synchronized Lunar Time and Earth's Axial Rotation

Examples of lunation time counts combined with different lunation year cycles to present applications for calendars are shown. Using mixed unit fractions, the whole (#) number becomes a k count of one in the following step up in time (moving from right to left).

Earth's axial rotations are synchronized with the Moon's lunation cycle. A temporal frame period of 13 recurrent lunations is designated as one year, the primary reference cycle for the calendar system. The secondary cycle for the calendar system is Earth's axial rotation based on a regular year of 384 days and synchronized in two intercalary events. The first is a leap year, the addition of one Earth rotation (385 day year) every ten 13-lunation years. A bidecadidal 20 13-lunation year cycle enters a long count system 13-lunation year on a 20 13-lunation year cycle. The second is a skip year, the removal of one Earth rotation (383) day on a necessary 10 or 20 13-lunation year intercalation event, this may fall near a count of 400 13-lunation years. Only after this invention's memory sets a repository for tracking these relational cycles with precision, will the cyclic synchronizations be confirmed. The moment the the two (or more) independent object-relative time scales, from two (or more) frames of reference are synchronized this pairing function equates to a shared temporal frame of reference for the calendar system.

TABLE 1
SI unit measures of best fit pairings for an observation
based lunation and solar day calendar are calculated.

| | | | Average | |
|---|---|---|---|---|
| | Total | Earth | solar | Accumulative |
| 13- | lunations | calendar | rotations of | delta in |
| Lunation | (New Moon | days/13- | Earth/13- | seconds |
| years | signal) | lunation year | lunation year | (over total days) |
| 1 | 13 | 384 | 383.897 644 | 8843.558 400 |
| | | | | (384 days) |
| 9 | 117 | 384 | | 79 592.025 600 |
| | | | | (3456 days) |
| 10 | 130 | 385 | | 2035.584 000 |
| | | | | (3841 days) |
| *420 | 5460 | 383 | | −905.471 307 |
| | | | | (161 320 days) |
| **400 | 5200 | 383 | | −0.010 288 |
| | | | | (153 638 days) |

SI unit delta calculations used one solar day equal to 86 400 seconds (as of 1967) and 1 lunation cycle equals the average of 29.530 588 days.(https://www.gpo.gov/)
*Due to limitations in modern timekeeping methods, using a fixed mean for Earth rotations/lunation and fixed rotational time, inaccuracies (or unknown measures) can accumulate.
**exploratory assignment of 1 lunation cycle variable to an average of 29.530 576 9231 days/lunation.

### Example 1: 20 Year Cycle(s) of 13 Lunations/Year, 13[20^{y}]=Lunation Count

$$\frac{0}{20 \text{?}} \cdot \frac{0}{{20}^{1}} \cdot \frac{0}{13} \cdot \frac{0}{18} \cdot \frac{18}{20} \to \frac{0}{20 \text{?}} \cdot \frac{0}{{20}^{1}} \cdot \frac{0}{13} \cdot \frac{0}{18} \cdot \frac{19}{20} \to \frac{0}{20 \text{?}} \cdot \frac{0}{{20}^{1}} \cdot \frac{0}{13} \cdot \frac{1}{18} \cdot \frac{0}{20} \to \frac{0}{20 \text{?}} \cdot \frac{0}{{20}^{1}} \cdot \frac{0}{12} \cdot \frac{1}{18} \cdot \frac{1}{20}$$

$$\text{?} \text{indicates text missing or illegible when filed}$$

### Example 2: 30 Year Cycle(s) of 12 Lunations/Year (Tabular Islamic Calendar), 12[30^{y}]=Lunation Count

$$\frac{0}{30 \text{?}} \cdot \frac{0}{3 {0}^{1}} \cdot \frac{0}{12} \cdot \frac{0}{18} \cdot \frac{18}{20} \to \frac{0}{30 \text{?}} \cdot \frac{0}{3 {0}^{1}} \cdot \frac{0}{12} \cdot \frac{0}{18} \cdot \frac{19}{20} \to \frac{0}{30 \text{?}} \cdot \frac{0}{3 {0}^{1}} \cdot \frac{0}{12} \cdot \frac{1}{18} \cdot \frac{0}{20} \to \frac{0}{30 \text{?}} \cdot \frac{0}{3 {0}^{1}} \cdot \frac{0}{12} \cdot \frac{1}{18} \cdot \frac{1}{20}$$

$$\text{?} \text{indicates text missing or illegible when filed}$$

Unlike ancient calendar and timekeeping systems from a pre-Julian calendar period (before 45 BCE), the modern Gregorian calendar is Earth specific and has an arbitrary start/stop position in space. Integrity, accuracy, and interoperability of a multi-celestial, or multi-object, timekeeping system is lost if the Gregorian calendar is used as a reference for the timekeeping system of embodiments of the present invention.

The present invention in one embodiment has a calendar cycle beginning, a start point that has an initial synchronization between a New Moon position for the lunar timekeeping system and an exact position on Earth that creates a 1D line connecting the height of the New Moon position with the Sun. This position on Earth marks the start point for Earth's independent axial rotation time scale, measured using relevant timekeeping system which becomes synchronized to the start of the lunation time system. The example of an ideal start position on Earth would be the Global Positioning System (GPS) coordinate aligned with a total solar eclipse, a temporal and spatial coordinate that corresponded to when the Sun was at its zenith (noon), creating the opposite (midnight) start position on the other side of the world. Subsequent cyclic synchronizations are set using Earth's fixed point's longitudinal coordinate, the temporal axial rotational coordinate of the start point, or Earth's UTC starting at this point. This method aligns both independent frames of reference synchronized by relational astronomical alignments and celestial timekeeping systems in two different frames of reference, applicable to this invention's multi-celestial timekeeping system.

As shown in FIG. 1, the stop positions in a cycle requires a defined (calculated) point in space and time to generate a 1D fundamental element that defines a 2D plane. The device then utilizes a zero-time modelling backdrop with time added in discrete geometric steps using counts associated with a division and subdivisional formula. A geometric model of the parent body (e.g., star for planets, or planet for satellites) is represented by a non-divisible point in zero-dimension. The time it takes for the orbiting object to complete a full cycle (from start back to modelled stop, Δtₓ) becomes represented by geometric formulas and can be presented using various geometric shapes and movements. The spatial distance (fundamental element) from the assigned start/stop position of the orbiting object (Earth) to the parent object (Sun) is defined as a 1D geometric element using two points, each associated with both object's center of mass. Both the cycle start position, the spatial distance, and the 2D plane for the device are captured at the same indivisible time point. In a time-differential model that embraces motion using speed and velocity, these time durations and distances will continually change, but these properties are not changing in the modelling system described for an embodiment of the present invention, change is only dimensionally expressed at tₓ and tₓ₊₁ (points in time), defined as a static system, between the start and stop points in the cycle, geometric motion is dictated by k counts determined by Δtₓ are used for the particular cycle.

A timekeeping device according to one embodiment of the present invention includes geometric displays of multiple integral space-time geometric models in a zero-time model for Earth's 24- and 12-hour division of rotation, a clockface. The geometric models in certain embodiments of the present invention expand to include any object or cycle, either celestial, atomic, and so on, but share both unique and common attributes for the invention whereby a canonicalization process enables different objects to be geometrically presented in equivalence relations. For example, Earth's and Mars' rotational time intervals are the same class and thus can be displayed on the timekeeping device in the same way, yet the timing of the count would be unique to each planet, as discussed in Vedic texts. Earth's and Mars' orbital time intervals are also the same class and can be presented in the timekeeping device the same way (for example, the hour, minute, and second hands of a clock).

A complete cycle can be geometrically presented in numerous ways but requires consistent derivation formulas for unit measures and scales to be displayed in a device display for meaningful comparisons in a customized display. These can include both advancement along a 1D line segment (see FIG. 3) as well as the perimeter of a closed geometric shape (FIG. 2), like a circle or square. Definitions of space-time boundaries, references, and planes are presented in FIG. 1. Combining geometric presentations of a Earth/Moon lunation model (FIG. 4) with a displays as shown in FIGS. 2, 3, and FIG. 5 is possible for customization of a particular timekeeping device and/or display.

For comparisons on a single timekeeping device display, unique properties are required to separate, yet also distinguish objects and their respective temporal interval being displayed. There are several different possibilities that can be used in embodiments of the present invention, either used independently or combined. In a two-dimensional display timekeeping device, this can include, but are not limited to, (1) using parallel spatiotemporal geometric 1D line segments where each line is constructed using temporal k vectors in a lattice until one line represents one cycle period count (see FIG. 3), (2) a circle that can be geometrically scaled by taking the fundamental element and applying uniform scaling the radius (FIG. 2C) using a unique spatial class divisor dihedral group (e.g., 360)/subdivisors (60¹) N=360(60^{y}) for example, (2) different colors (e.g., blue for Earth, or red for Mars), or (3) different geometric shapes. For example, presenting a blue circle for one orbital cycle (Earth's orbit) with an overlapping isoperimetric red square for another orbital cycle (Mars's orbit), or spatial scaling the radius of a temporal orbital circle related to the defined orbital distance using the shared, start/stop position of each entity (options can include apoapsis, periapsis, mean orbital distances, semiminor, or semimajor distances, and so on) (FIG. 1). The timekeeping device according to one embodiment of the present invention can also advance k+1 geometric temporal vectors using a counter-clockwise Archimedean spiral (not shown) (regardless of user selected view) within a polar coordinate grid the spatial representation of the circle radius creating a perimeter of a full cycle equal to the scaled measure of the temporal counts of the cycle. Archimedean spirals require radials that are defined by the divisor for N, or in the case or rotational time, for example 24 radials in the polar coordinate system.

The direction of adding discrete integral space-time temporal vectors in a zero-time lattice for the timekeeping device to display motion using integral kinematics can be either right to left or vise versa, also, in a circular path, clockwise and counterclockwise but each entity requires a consistent direction for comparisons in a selected display. To align with current timekeeping devices, rotational timekeeping maintains a clockwise rotation. For orbital timekeeping, the user can present either a clockwise or counterclockwise display. A user can select either a reference of Earth's South Pole view presenting a clockwise temporal advancement (consistent with timekeeping systems), or counterclockwise advancement if aligned with a North Pole view (consistent with standardized time-derivative spatial models of the solar system); this can be offered as a user customized view of the comparative model.

In the multi-celestial (object-relative cycle) timekeeping device, each cycle input (Δtₓ) that is divided and subdivided can be defined by a standardized unit of time, SI unit second using current decimal notation but also applicable using unit fraction technology, that can attribute the number of seconds of a temporal interval to each k count (FIG. 6). A simple introduction for example, is that Earth's orbit is approximately 365.2419 SI days, converted to 31 556 900.16 seconds. Therefore, each k unit with N=360 units in Earth's orbit would be 87 658.056 seconds/k count unit. Units as they are added to make a geometric magnitude, can be either displayed as a sum of 1 D lines, arcs in a circle construct, sides of a polygon, and so (see FIGS. 2, 3 and 4). Another example of a temporal property of a k unit is a lunation Kin, when one lunation is measured as 29.53058770576 days

$$\frac{2 \; 505 600.531 seconds}{360} = 6960.00$$

seconds/kin. A similar mechanism is used to convert a full planet rotation into 24 divisions as well as 1440 and 86 400 subdivisions using a solar reference start/stop to inform a timekeeping device when so called “hour”, “minute”, and “second” hands are displayed for a particular planet.

For geometric motion, given the geometric element length (straight geometric element for a line, arc geometric element length for a circle) (L) for each time-integral temporal element k count (a zero-time temporal geometric (T) element) the timing of discrete geometric count advancements requires a conversion factor to a familiar standardize unit of time. For example,

$$1 \frac{0}{8 \; 748 \; 000 \; 000} {Earth}_{orbit} ( solar reference ) = 31 \; 556 925.22 seconds / solar year ,$$

therefore in this conversion, incremental advancement of this element k (a geometric ordered temporal vector for Earth's orbital cycle) can be added every 0.003 607 seconds/k given a second is defined using a time-derivative function. Any agreed upon time standard can be used to “time” the placements for the next discrete and ordered vector element, the actual physical quality of the interval would not change. For example, if humanity used a sideral rotation to define a “second”, instead of the original referenced solar rotation, it would be 0.003 597 “seconds”/k in this example. When considering a circle circumference for the geometric display device, each k count would be 1 degree of a circumference (if N=360). A conversion factor for each k is required for every canonical reference used in the timekeeping device. Each entity specific length (L) of k would be placed in time relative to a single standardize unit (e.g., 1 second, SI Unit).

For displaying multiple object orbital periods, a reference (canonical) is a defined complete cycle, an example would be

$$1 \frac{0}{360} {Mars}_{orbit} ( solar reference ) ,$$

where N=360=12(30)¹, other orbits would then be compared to this interval, for example Earth's orbit in counts would be

$$1 \frac{317.12}{360} {Earth}_{orbit} ( solar reference ) .$$

Alternatively, any single cycle can be selected as the canonical for the displayed class and celestial entities, for example,

$$1 \frac{0}{360} {Earth}_{orbit} ( solar reference )$$

can also be used. To maintain natural numbers (no decimals) for mixed unit fraction methodologies for timekeeping in the geometric model, aligned with unit fraction methodology, temporal subdivisions can be extended where for example N=12(30)⁶=8 748 000 000 and presented as

$$1 \frac{0}{8 \; 748 \; 000 \; 000} {Mars}_{orbit} ( solar reference )$$

equal to a temporal interval of

$$1 \frac{7 \; 681 \; 716 \; 553}{8 \; 748 \; 000 \; 000} {Earth}_{orbit} ( solar reference ) .$$

For each object orbit, there are more than one definable position in space that can be used to align multiple celestial objects in orbit of a single parent object. The distance from the geometric center for each object to the geometric center for the parent object creates a fundamental geometric element, unique to the orbiting object and position in space and time for that object. These positions can include, but not limited to, (1) apoapsis distance (2) periapsis distance, (3) mean orbital distance, or (4) semimajor/semiminor positions but need to be consistent for a single multi-celestial display for ease of comparison. Each fundamental element can be scaled using the same uniform scaling system to generate geometric scaled spatial models that can be used to present temporal cycle geometric constructs. For a circular temporal geometric construct, a spatial radius would define the radius but the count (k) of arc lengths are ordered temporal vector elements (distance and direction) in the zero-time model where when k=N, the full cycle and circle is complete. The time it takes for the centre of the orbiting object to reach their respective start/stop position is considered one cycle for that object. This invention conserves both spatial and temporal relationships for objects orbiting the same parent body. The entity specific geometric spatiotemporal constructs are built upon a zero-time model, use uniform scalars, and defined in both space and time; therefore, the properties of motion are a natural quality in a time-integral model. This motion occurs within a non-zero region of variable discrete time intervals (using a object-relative start/stop cycle) between points in discrete time. These distances and temporal intervals would be constantly shifting in a time-derivative model. A similar effect of SI unit basing time on Cs133 transitions but in a zero-time modelled state.

One lunation cycle can be numerically counted using mixed geometric unit fractions as

$$1 \frac{0}{18} = \frac{18}{18} ,$$

which also equals

$$1 \frac{0}{18 ( 20 )} = \frac{360}{360} = 1 lunation cycle .$$

This time unit system is inspired by the ancient texts, including Maya timekeeping system related to the Tun 360-day calendar hypothesis yet used in this invention for application to a lunation cycle. Further precision of time, beyond 1 kin is based on an orbital division exponential system; N=18(20)^{y} system (although a 10-base system is also possible, as currently used for seconds (rotational cycle), e.g., 25 kins, 25.1 kins, 25.2 kins . . . , 25.9 kins, 30.0 kins . . . , however such a system is only suggested for a rotational time-based system to maintain consistency with known historic references and modern applications). This object of the present invention does not contradict, and can also be user selected in the display, a single cycle lunation calendar (12-lunations/year) as well as a dual cycle luniterranean calendar, originally called the McKenna-Meyer calendar, where 13 lunations equals one luniterranean year. For a luniterranean calendar (using New Moon position as the variable discrete time start/stop position to set the input, Δt) for timekeeping devices, the system must include harmonization of a lunation primary cycle harmonize a secondary cycle of Earth's axial rotation using three modelled intercalations, a mathematically modelled (a) intercalary insertion event of time each lunation (˜11.266 hours, divided 30 Earth rotations (SI units)/Earth rotation period, or Δt FIG. 6) presented in this invention, as well as previously published intercalary intervals of (b) nine 384-day regular years, and a 385-day leap year every tenth 13-lunation cycle, and (c) a 383-day skip year every 454.5 13-luntation year (or full moon on 454th 13-lunation cycle).

Geometric modelling motion can include a framework that utilizes both time-integrals of displacement (absement) and time-derivative of position (velocity, acceleration). For integral kinematics (time integrals of displacement), motion geometry can include the application of Euclidean translations, motion of fixed-points for a construct(s) moving along a linear or circular glide using entity specific scaled dimensional measures of length and time (L′T) (dimensional units of absement). Both measures of length and time can be presented as geometric modelled elements that can be uniformly scaled and counted in zero-time models. FIG. 5 presents a geometric model of a Earth/Moon relationship at a New Moon that can “move” with Euclidean translations along a 1D geometric timeline (see FIG. 3) with Earth's geometric center as a point of time (FIG. 3viii). Using an input-driven stack pushdown automata where each lunation specific Earth/Moon geometric model can be placed, or displayed, at the related temporal point along the 1D line, or 2D device display. For example, at a current solar eclipse, a solar eclipse geometric model would appear in the timekeeping device (FIG. 4D).

The device display can be multi-dimensional (1D, 2D, 3D, or holographic). Each scaled entity specific spatiotemporal unit is defined within the same zero-time interval and compared using geometric functions.

The watch face can be used to visually track the Moon's orbital time around Earth's representation showing its relative position to the Sun (triangle symbol at top of watch face) and Earth (position of observer) helping predict lunar phases (New Moon, Full Moon, and phases in between).

The device can be customized to present celestial based calendars, for example, the Tabular Islamic calendar (one primary celestial cycle, no synchronized cycles), (single cycle) 12 months; based upon visual confirmation of a New Moon position. The device can incorporate both a visual confirmation (requiring user to advance the month) as well as a mathematical Tabular Islamic calendar transitioning based on mathematical formulas. Given accumulation of slight variances each cycle, visual confirmation of a New Moon presents a more accurate long-term synchronization for a device mechanism.

Based on a user's frame of reference, a device can maintain a synchronized Earth axial rotation (23:59:59) and Moon lunation (17:19:19) timekeeping display (see as discussed above]). Based on the user's frame of reference (either the Moon or Earth) the device synchronizes to the relevant user's frame's object's relative coordinated time. The displayed time for the distant object's time scale is adjusted as per this invention where each present cycle is a calculated prediction based on the object-relative CPU and memory system (see FIG. 8, using Earth frame of reference with orbiting Moon, and FIG. 9, using Moon frame of reference with rotating Earth). Each predicted temporal interval (tₓ+Δtₓ) cyclically updated when complete (see summary above).

In other embodiments, the watch can display lunisolar and luniterranean calendar system(s), each based on a primary lunation cycle. A primary lunation reference is the most common celestial reference cycle of all global calendars.

Devices and methods according to embodiments of the present invention can be implemented in devices where a CPU and memory are programmed with instructions, including optional frame of reference, for carrying out methods according to embodiments of the present invention and displaying graphical representations of timekeeping on a user interface such as a digital display, screen or monitor. Examples of devices and environments in which the present invention may be implemented include smart watches (including for example an Apple watch), computing devices having a monitor or display, smart phones, tablet computers, and a web-based applications. The present invention can also be embodied in an app such as an app for a smart phone.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A method of celestial timekeeping comprising:
A) selecting a first celestial object;
B) selecting a second celestial object which undergoes a motion cycle where the motion cycle is defined relative to the first object;
C) selecting a reference signal to serve as both a start and a stop signal for the motion cycle, where the reference signal is defined by a relational event shared by the first and second objects;
D) measuring the duration of the motion cycle in a first coordinated time system in a first user's frame of reference, wherein the coordinated time system comprises first coordinated time system units of time;
E) dividing the measured duration of the motion cycle into motion cycle duration units;
F) setting a first clock in the first user's frame of reference to run according to the motion cycle duration units such that the first clock complete a complete clock cycle each time the motion cycle duration units equal to the measured motion cycle duration elapses; and
G) displaying the measured motion cycle duration on a display device.

33. The method of claim 32, further comprising repeating steps D) to F) thereby updating synchronization of the first clock with the motion cycle duration.

34. The method of claim 32, wherein step F) further comprises relating the motion cycle duration units to a corresponding number of the first coordinated time system units of time.

35. The method of claim 32, further comprising representing each of the motion cycle units as an algebraic number, dots, a line, or a geometric shape on the display device.

36. The method of claim 35, further comprising displaying a subset of the dots, a portion of the line, or a portion of the geometric shape commensurate with an elapsed duration of the complete clock cycle.

37. The method of claim 35, wherein the measured motion cycle duration units are advanced using an SI unit of time when the first clock is within the Universal Coordinated Time (UTC).

38. The method of claim 35, wherein the measured motion cycle duration units are advanced using a standard of time for Lunar Coordinated Time (LTC) when the first clock is within the LTC.

39. The method of claim 35, wherein the reference is selected from the group consisting of an apogee, a perigee, and a lunar (satellite) phase relative to a planet and a system star.

40. The method of claim 32, wherein step E) further comprises dividing the measured duration of the motion cycle into intervals of time using the formula N=n[f(b)^{y})]) where N is total unit count of the motion cycle units, n is a divisor and b is a sub-divisor.

41. The method of claim 32, further comprising carrying out steps A) to G) for a third celestial object and a fourth celestial object and simultaneously second motion cycle duration units on the display device.

42. The method of claim 32, further comprising carrying out steps A) to G) in a second user's frame of reference whereby a second clock in the second user's frame of reference is set to run according to the motion cycle duration units whereby the first and second clocks are synchronised.

43. A celestial object timekeeping device comprising:
a display;
a processor communicatively connected to the display;
a memory communicatively connected to the processor;
a communications interface communicatively connected to the processor;
the processor configured to implement an instruction set comprising processor instructions comprising instructions for:
A) receiving a user selection of a first celestial object;
B) receiving a user selection of a second object which undergoes a motion cycle where the motion cycle is defined relative to the first celestial object;
C) receiving a user selection of a reference to serve as both a start signal and a stop signal for the motion cycle, where the reference is defined by a relational event shared by the first and second objects;
D) receiving, via a communications interface, a measured duration of the motion cycle in a first coordinated time system in a first user's frame of reference, wherein the coordinated time system comprises first coordinated time system units of time;
E) dividing the measured duration of the motion cycle into motion cycle duration units;
F) setting device to run according to the motion cycle duration units such that the device completes a complete clock cycle each time the motion cycle duration units equal to the measured motion cycle duration elapses; and
G) displaying the measured motion cycle duration on the display.

44. The device of claim 43, further comprising repeating operations D) to F) thereby updating synchronization of the device with the motion cycle duration.

45. The device of claim 43, wherein step E) further comprises relating the motion cycle duration units to a corresponding measure using the first coordinated time system units of time.

46. The device of claim 45, further comprising representing each of the motion cycle units as an algebraic number, dots, a line, or a geometric shape on the display.

47. The device of claim 46, further comprising displaying a subset of the dots, a portion of the line, or a portion of the geometric shape commensurate with an elapsed duration of the complete clock cycle.

48. The device of claim 46, wherein the measured motion cycle duration is expressed in an SI unit of time when the first clock is within the Universal Coordinated Time (UTC).

49. The device of claim 46, wherein the measured motion cycle duration is expressed as a standard of time for Lunar Coordinated Time (LTC) when the first clock is within the LTC.

50. The device of claim 46, wherein the reference is selected from the group consisting of an apogee, a perigee, and a lunar (satellite) phase relative to a planet and a system star.

51. The device of claim 43, wherein operation E) further comprises dividing the measured duration of the motion cycle into intervals of time using the formula N=n[f(b^{y})]) where N is total unit count of the motion cycle units, n is a divisor and b is a sub-divisor.

52. The device of claim 43, further comprising carrying out operations A) to G) for a third celestial object and a fourth celestial object and simultaneously displaying second motion cycle duration units on the display.

53. The device of claim 43, wherein the device is synchronized with a second device in a second frame of reference where the device and the second device run according to the motion cycle duration units.
